(19) United States
(12) Patent Application Publication
(10) Pub. No.: US 2007/0018511 A1
(43) Pub. Date: Jan. 25, 2007

(54) Linear displacement system for a driving simulator

(76) Inventor: Thomas Schulz, Berlin (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/547,209

(22) PCT Filed: Jan. 14, 2004
(86) PCT No.: PCT/EP04/00185

§ 371 Date: Jun. 29, 2006

(30) Foreign Application Priority Data
Feb. 26, 2003 (DE) 103 08 059.7

(51) Int. Cl. H02K 41/00

(52) U.S. Cl. 310/12; 472/43

(57) ABSTRACT

A linear displacement system (10) for a base carriage (3) mounted so that it can be displaced freely on a flat floor surface (8) comprises a drive unit (12) for controlled pulling and/or pushing of the base carriage (3) relative to the floor surface (8) and a guide frame (11), which spans the movement space of the base carriage (3) in the movement direction (Y). According to the invention, the linear displacement system (10) has a motor carriage (15) which can be displaced freely on the flat floor surface (8) and can be displaced relative to the guide frame (11) with the aid of the drive unit (12); the base carriage (3) is joined to the motor carriage (15) rigidly or via an articulation (16). This configuration of the linear displacement system (10) ensures weight relief of the guide frame (11) since components of the drive unit (12) with heavy weights can be mounted on the motor carriage (15) which is supported relative to the floor surface (8). The linear displacement system (10) is suitable, in particular, for use in a motion unit (1) for a driving simulator (2) to generate motion effects on test persons.

### BACKGROUND OF THE INVENTION

1. Field of the invention

The invention relates to a linear displacement system for a base carriage mounted so that it can be displaced freely on a flat floor surface, in particular as part of a motion unit for a driving simulator, according to the precharacterizing clause of claim 1, as is disclosed for example by (unpublished patent application 101 50 382.2-35).

2. Related Art of the Invention

(Unpublished patent application 101 50 382.2-35) describes a motion system for a driving simulator. The motion system comprises a cabin which accommodates the test person; this cabin is provided with a seat arranged so that it can move and operating elements arranged so that they can move, with the aid of which high and medium frequency excitations can be exerted on the test person. The cabin is fastened on a turntable which, for its part, is carried by a hexa-axial motion unit. The combination of the cabin, turntable and hexa-axial motion unit is fitted on a base carriage, which is mounted so that it can be displaced freely on a flat floor surface and can be pulled and/or pushed over this floor surface with the aid of a horizontal displacement device.

Mounting the base carriage on the floor plate means that the entire weight of the base carriage, and of the equipment carried by it, is exerted directly on the floor plate—i.e. without the intervention of the horizontal displacement device. The horizontal displacement device does not therefore need to carry the base carriage together with its equipment, but is used exclusively for the horizontal motion excitation of the base carriage—i.e. displacement and acceleration in the horizontal direction. Owing to this motion concept, the function of “carrying” the base carriage is decoupled from the function of “guiding” the base carriage.

The horizontal displacement device for pulling/pushing the base carriage on the floor plate in (unpublished patent application 101 50 382.2-35) comprises two linear displacement systems, namely
a first linear displacement system for displacing/accelerating the base carriage along a first horizontal axis (Y), and
a second linear displacement system for displacing/accelerating the combination of the first linear displacement system and the base carriage along a second horizontal axis (X), which is approximately aligned perpendicularly relative to the first horizontal axis (Y).

This configuration of a horizontal displacement device entails cascading of the motion system, since the horizontal motion is carried out by two linear displacement systems hierarchically connected to each other. The second linear displacement system in the exemplary embodiment of (unpublished patent application 101 50 382.2-35) is configured as a bridge-like guide frame (“portal bridge” or “traverse”) which spans the entire base surface transversely to its motion direction—i.e. in the Y direction; at its two ends, this guide frame is supported on rails (or alternative guide means) and is displaced and accelerated along these rails in the X direction with the aid of linear drives. In the guide frame, the first linear displacement system is integrated with a drive unit which can displace or accelerate the base carriage in the Y direction. The base carriage is joined to the first linear displacement system via coupling rods, which are intended to compensate for rotations and rocking between the base carriage and the guide frame.

Owing to the integration of the first linear displacement system in the guide frame, the latter is exposed to significant weight loads which can lead to (static and dynamic) deformations of the guide frame. In order to avoid compromising the function of the linear displacement system, however, only very minor deformations of the guide frame are permissible. Very stringent requirements are therefore placed on the guide frame—large span width and negligibly small deformations under heavy weight loading. The design and technical material requirements associated with this are very difficult to manage in practice—especially those in the case of large span widths.

### SUMMARY OF THE INVENTION

It is therefore an object of the invention to configure the first linear displacement system in such a way that the guide frame is relieved of weight—with equal security of the base carriage against tilting and a high stability of the overall system.

The object is achieved according to the invention by the features of claim 1.

Accordingly, the first linear displacement system of the guide frame is provided with an additional component, namely a motor carriage which can be displaced on the flat floor surface, and to which the base carriage is joined—rigidly or via an articulation. The motor carriage is driven with the aid of the drive unit of the linear displacement system, and is supported on the floor surface; the (heavy weight) drive components of the linear displacement system can therefore be relocated from the guide frame onto the motor carriage, which leads to significant load relief of the guide frame. In order to accelerate the base carriage in the motion direction of the first linear displacement system, the drive unit of the linear displacement system exerts the requisite acceleration forces on the motor carriage, which in turn transmits these forces to the base carriage. The motor carriage sliding on the floor surface according to the invention therefore fulfils several functions:
holding heavy weight drive components,
transmitting the forces between the guide frame and the base carriage in the horizontal direction,
supporting the base carriage in the vertical direction, and
counterweight for the base carriage, which reduces the susceptibility to tilting.

In order to make the displacements and accelerations of the base carriage and the motor carriage smooth, the friction between the carriages and the floor surface must be as low as possible. Preferably, therefore, the carriages are mounted relative to the floor surface via air bearings and/or air cushions (claims 2 and 3). Such an air bearing allows free displacement of the carriages on the floor surface and is associated with minimal friction forces between the carriages and the floor surface. Air bearings are furthermore distinguished by high stiffness, which constitutes an important prerequisite for unimpeded sliding of the carriages on the floor surface. Alternatively, the base carriage and/or the motor carriage may also be mounted relative to the floor surface via gliding bearings or rocking bearings.

In a preferred embodiment of the invention, the base carriage is joined to the guide frame via not one but two motor carriages, which are arranged mutually offset (claim 4). Two spatially separate, synchronously operated drive units are provided in order to drive the two motor carriages. The stability of the overall system can thereby be increased, so that the risk of tilting is reduced.

An electromagnetic linear drive is preferably used as the drive unit of the linear displacement system (claim 5). Compared to other drives (for example tensioned belt drives), this drive concept has the advantage of a compact structure. Furthermore, the risk of uncoordinated mechanical vibration excitations of the system is substantially prevented when electromagnetic linear drives are used. Since electromagnetic linear drives do not require any intermediate gearing, they furthermore have particularly low friction.

The electromagnetic linear drive is preferably designed as a synchronous motor (see claim 6). Unlike an asynchronous motor, in which the opposing field in the secondary coils is generated by induction, the opposing field in a synchronous motor is “built-in” in the form of permanent magnets. Synchronous motors have the advantage that the “magnetic air gap” (between the permanent magnets and the primary coils) plays much less of a role than in an asynchronous motor. For comparable forces, synchronous motors can therefore be operated with a significantly larger “magnetic air gap”; furthermore, the dependency of the force on air-gap fluctuations is limited owing to their very principle. This is also advantageous, above all, for controllability during operation and therefore adjustability of the force. Although all these reasons militate in favor of using a synchronous motor, it is nevertheless (in principle) also possible to use asynchronous motors.

The (heavy weight) primary coils expediently form part of the motor carriage, while the (lighter weight) permanent magnets are integrated in the guide frame. In this way—owing to the relocation of the primary coils—the load on the guide frame is significantly relieved.

In a preferred embodiment, the permanent magnets of the guide frame are in the form of flat panels or ribs arranged successively in the displacement direction (Y) of the linear drive. These panel-like permanent magnets engage in U-shaped primary coils of the motor carriage (claim 7). The series of permanent magnets then spans the entire motion space of the linear displacement system. The inter-engaging permanent magnets/primary coils are preferably oriented vertically, so that the permanent magnets protrude vertically downward from the guide frame. The system is therefore insensitive to relative motions in the vertical (Z) direction between the guide frame and the motor carriage; this furthermore minimizes the bending forces and bending moments which act on the guide frame owing to the weight of the permanent magnets.

In order to guide the motor carriage very accurately relative to the guide frame, and in order to be able to keep the air gap constant between the primary coil of the motor carriage and the permanent magnets of the guide frame, additional air bearings which support and guide the motor carriage relative to the guide frame are expediently provided on the motor carriage (claim 8).

The base carriage is preferably joined to the motor carriage or carriages via a rotary articulation (claim 9). In contrast to rigid coupling between the base carriage in the motor carriage—which would mean overengineering the system—such an articulation allows rotations of the base carriage relative to the motor carriage which may occur due to deformations and floor irregularities.

The rotary articulation which couples the base carriage to the motor carriage is preferably arranged at the height of the center of mass of the base carriage, the carried object and the motor carriage (claim 10). With this type of coupling, the X and Y forces transmitted from the motor carriage to the base carriage are introduced into the base carriage at the height of the center of mass, which minimizes the risk of tilting the base carriage (due to torques about the X or Y axes).

In order to further reduce the risk of tilting the base carriage, it is also preferable for the other side of the base carriage from the motor carriage to be supported relative to the floor surface. A head support, which is coupled to the base carriage via a rotary articulation and is mounted so that it can be displaced on the floor surface, is used for this purpose (claim 11). The head support may also be supported relative to the base carriage via coupling elements (claim 12).

### BRIEF DESCRIPTION OF THE DRAWINGS

The invention will be explained more detail below with reference to an exemplary embodiment represented in the drawings, in which:

FIG. 1 shows a schematic view, not true to the scale, of a base carriage coupled to a guide frame via a motor carriage . . .

FIG. 1a . . . in a sectional representation and

FIG. 1b . . . in a plan view;

FIG. 2 shows a detail of the motor carriage

FIG. 2a . . . in a perspective view,

FIG. 2b . . . in a sectional representation

FIG. 2c . . . in a plan view.

### DETAILED DESCRIPTION OF THE INVENTION

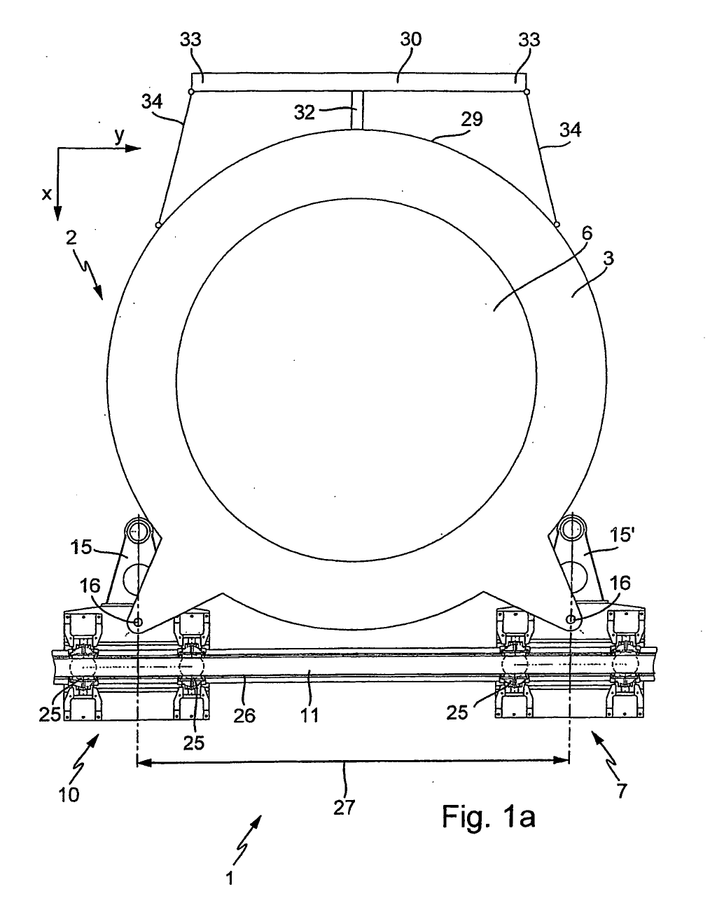

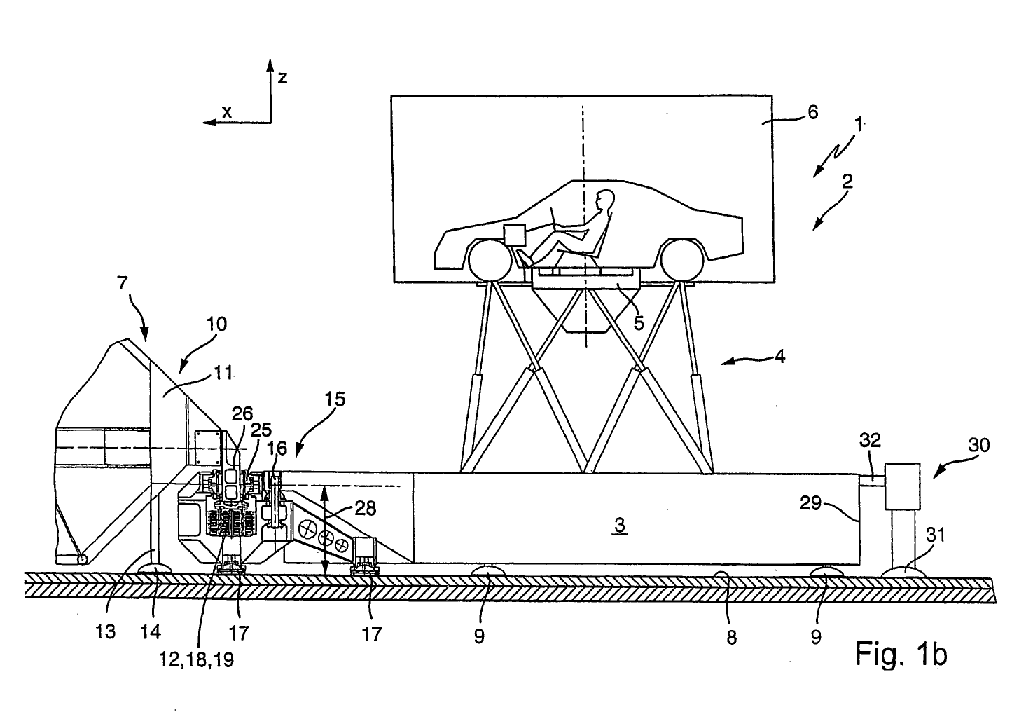

FIGS. 1a and 1b show, in a schematic representation, a detail of a motion system 1 for a driving simulator 2 to generate motion impressions on a test person. The motion system 1 comprises a base carriage 3, on which a hexa-axial motion unit 4, a turntable 5 and a cabin 6 are arranged. With the aid of the hexa-axial motion unit 4 and the turntable 5, the cabin 6 can be moved in all six degrees of freedom (three degrees of freedom in translation and three degrees of freedom in rotation) relative to the base carriage 3. For controlled displacement and acceleration of the combination of the base carriage 3, the hexa-axial motion unit 4, the turntable 5 and the cabin 6 along the two horizontal axes X and Y, the motion system 1 of the driving simulator 2 furthermore comprises a horizontal displacement device 7, which spans a large motion space (of 20 meters or more) in both the X and Y directions and can exert low frequency motion impressions on the test person. With respect to a detailed description of the motion system 1 and its components, reference is made to (unpublished patent application 101 50 382.2-35) the disclosure of which is hereby incorporated into this application.

In order to be able to apply the speeds and accelerations required for different driving maneuvers with high resolution and quality, the base carriage 3 with the load 4, 5, 6 on it—which overall is several tonnes in weight—must be mounted with the least possible fiction relative to the floor surface 8. In the exemplary embodiment of FIGS. 1a and 1b, this is done by mounting the base carriage 3 relative to the floor surface 8 with an air bearing 9.

The horizontal displacement device 7 of the driving simulator the motion system 1 consists of two linear displacement systems, which are arranged mutually orthogonally with respect to their motion directions. A first linear displacement system 10 displaces and accelerates the base carriage 3 together with the components 4, 5, 6 arranged on it in the Y direction. A further, second linear displacement system (not shown in the figures) displaces and accelerates the combination of the base carriage 3 and the first linear displacement system 10 along the X direction.

The first linear displacement system 10 comprises a guide frame 11—also referred to below as a “traverse” 11—which spans the entire motion space of the base carriage 3 in the Y direction. In the application of the driving simulator motion system 1 as described here, the traverse 11 is mobile in the X direction and is accelerated and displaced in a controlled way the x direction with the aid of the second linear displacement system (not shown in the figures). In order to reduce the bending under its own weight while simultaneously minimizing the installation space requirement in the vertical (Z) direction, the traverse 11 may—besides feet on its ends—be supported relative to the floor surface 8 by a plurality of props 13 distributed in the Y direction. The props 13 are mounted relative to the floor surface 8 via air bearings 14 or gliding air cushion elements, in order to ensure low-friction displacement of the traverse 11 in the X direction. The position and stiffness of the props 13 will be determined by technical vibration considerations. If displacement in the X is not required, than the traverse 11 may be mounted stationary relative to the floor surface 8.

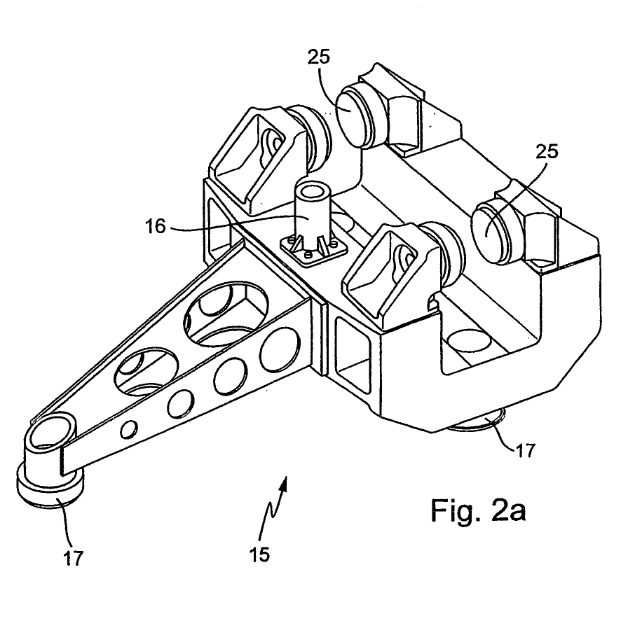

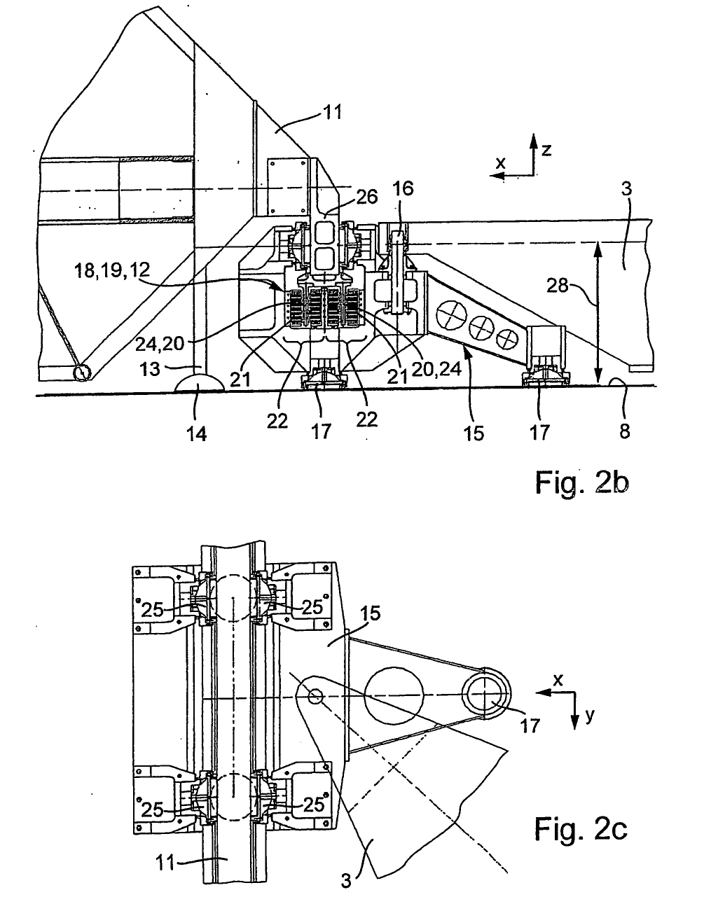

A drive unit 12, which can pull and/or pull the base carriage 3 in a controlled way in the Y direction, is provided on the traverse 11 in order to displace the base carriage 3 linearly in the Y direction. However—in contrast to the one in (unpublished patent application 101 50 382.2-35)—the base carriage 3 is not joined to the drive unit via coupling rods, but instead the base carriage 3 is driven according to the invention with the aid of a motor carriage 15 (shown in a perspective representation in FIG. 2a) which is displaced and accelerated along the traverse 11 with the aid of the drive unit 12 and is coupled to the base carriage 3 via an articulation 16. The motor carriage 15 is mounted so that it can be displaced freely relative to the floor surface 8 via air bearings 17.

The drive unit 12 is formed by an electromagnetic linear direct drive 18. The functional principle of such a drive 18 corresponds to an “unrolled” electric motor. Electromagnetic linear drives have the advantage of working without the use of mechanically moved force transmission members or gears. This improves the quality of the motion representation, since the friction in the system is minimal—especially when air bearings 14, 17 are used as support and guide elements. Availability is furthermore increased, since there are no components susceptible to wear (for example gears or steel belts) which often necessitate maintenance pauses. As an alternative to an electromagnetic linear direct drive 18, however, a belt drive or the like may also be used if need be.

In the present exemplary embodiment, the drive unit 12 is formed by synchronous motors 19 with permanent magnets 20 and primary coils 21. The primary coils 21 are integrated in the motor carriage 15. This can be seen in FIG. 2b, although the primary coils 21 are not shown in FIG. 2a for the sake of clarity. The motor carriage 15 has four primary coils 21, which are aligned parallel to the traverse 11 (i.e. parallel to the motion direction Y) and form two mutually parallel coil assembly 22. A slot-like cavity 23, which is open at the top and in which the permanent magnets 20 fastened on the traverse 11 engage, is arranged between the two associated individual coils 21 in each coil assemblies 22. For their part, the permanent magnets 20 have the shape of flat plane plates 24 or ribs and are fitted on the traverse 11 in two mutually parallel rows and are aligned so that they protrude downward in the vertical (Z) direction.

The inside width of the cavities 23 is matched to the layer thickness of the magnet plates 24 in such a way that an air gap is provided between the primary coils 21 and the magnet plates 24: Since the size of this air gap has a great influence on the strength of the induced currents and therefore the resulting force of the motor, this air gap should be as small as possible in order to ensure a sufficient power density of the motor. However, a small air gap can be produced only if the motion of the motor carriage 15 takes place very accurately parallel to the permanent magnets 20 of the traverse 11. This highly accurate guiding of the motor carriage 15 relative to the traverse 11 is achieved in the present exemplary embodiment by two pairs of air bearings 25—arranged mutually offset in the Y direction—which engage on a flat guide rail 26 formed on the traverse 11. As can be seen in FIG. 2b, the permanent magnets 20 are joined directly to the guide rail 26; this spatial proximity of the drive motor 12 to the air bearing guides 25, 26 ensures that the primary coils 21 of the motor carriage 15 can be guided very accurately relative to the magnet plates 24 of the traverse 11 so that—without risk of collision—a small air gap can be produced.

In the present exemplary embodiment, the base carriage 3 is joined to the traverse 11 with the aid of two motor carriages 15, 15′. The two motor carriages 15, 15′ are arranged mutually offset on the traverse 11 by a spacing 27. By synchronized excitation of the coil assemblies 21 of the two motor carriages 15, 15′, the associated drive units 12, 12′ are operated synchronously so that the two motor carriages 15, 15′ can be moved to and fro synchronously with each other on the traverse 11.

The base carriage 3 is coupled to the motor carriages 15, 15′ via rotary articulations 16, 16′. Since these two articulations 16, 16′ are arranged mutually offset in the Y direction by the spacing 27, rotary movements of the base carriage 3 about the vertical (Z) axis are effectively prevented by this arrangement. The height 28 of the rotary articulations 16, 16′ relative to the floor surface 8 (and therefore the height 28 where the base carriage 3 is coupled to the motor carriages 15, 15′) is selected so that it corresponds to the height of the centroid of the combination of the base unit 3, the hexa-axial motion unit 4 and the turntable 5 and the cabin 6. The forces induced in the base carriage 3 by the motor carriages 15, 15′ therefore engage accurately at the centroid height 28, so that tilting and rocking movements about the horizontal X and Y axes are minimized. This coupling of the base carriage 3 to the traverse with the aid of two motor carriages 15, 15′ reduces the susceptibility of the overall system to rotating, tilting and rocking in all three space axes.

In order to further stabilize the overall system 1, the base carriage 3 is provided with a so-called “head support” 30 on its opposite sign 29 from the motor carriages 15, 15′. The head support 30 is mounted via an air bearing 31 so that it can be displaced freely on the floor surface 8 and is joined to the base carriage 3 via a rotary articulation 32 (allowing rotations about the X axis). The linear dimensions of the head support 30 in the Y direction ensure additional stabilization of the base carriage 3 with the structures 4, 5, 6 against tilting and rolling movements. In order to support the base carriage 3 on the head support 30, the ends 33 of the head support 30 are joined to the base carriage 3 via coupling rods 34. The points where the coupling rods 34 and the rotary articulations 32 are coupled to the base carriage 3 are preferably at the height of the center of mass 28.

For rolling stabilization, the rotary articulations 32 may be provided with an active or passive spring/dampener element with or without an end stop, which returns the base carriage 3 to the original position in the event of rotary excursions. When active rolling stabilization of the base carriage 3 is used, sensors are fastened on the base carriage 3 in order to detect rolling and tilting excursions of the base carriage 3 and lock the rotary articulations 32 in case of an impending tilt.

If the base carriage 3 is joined to the guide frame 11 via motor carriages 15, and a head support 30 is furthermore provided, then the base carriage 3 may be mounted relative to the floor surface 8 exclusively via the air bearings 17, 31 of the motor carriages 15 and of the head support 31, so that the (additional) air bearing 9 on the lower side of the base carriage 3, as shown in FIG. 1b, may be obviated.

Besides the application example shown in FIGS. 1 and 2, which describes the special case of a motion system 1 for a driving simulator 2, the linear displacement system 10 according to the invention is also suitable for a wide range of other applications in which a load 4, 5, 6 is intended to be displaced relative to a floor plate 8 with high accuracy and low friction.

1. A linear displacement system (10) for a base carriage (3) mounted so that it can be displaced freely on a flat floor surface (8), in particular as part of a motion unit (1) for a driving simulator (2) to generate motion impressions for test persons, wherein
the linear displacement system (10) comprises a drive unit (12) for controlled pulling and/or pushing of the base carriage (3) relative to the floor surface (8),
the linear displacement system (10) comprises a guide frame (11) which spans the movement space of the base carriage (3) in the movement direction (Y),
the linear displacement system (10) has a motor carriage (15) which can be displaced freely on the flat floor surface (8) and can be displaced relative to the guide frame (11) with the aid of the drive unit (12), and
the base carriage (3) is joined to the motor carriage (15) rigidly or via an articulation (16).

2. The linear displacement system as claimed in claim 1, wherein the base carriage (3) is mounted relative to the floor surface (8) via air bearings (9) and/or air cushions.

3. The linear displacement system as claimed in claim 1, wherein the motor carriage (15) is mounted relative to the floor surface (8) via air bearings (17) and/or air cushions.

4. The linear displacement system as claimed in claim 1, wherein the base carriage (3) is joined to two motor carriages (15, 15′) which are arranged offset relative to each other and can both be displaced synchronously with each other relative to the guide frame (11) with the aid of a drive unit (12, 12′).

5. The linear displacement system as claimed in claim 1, wherein the drive unit (12) is an electromagnetic linear drive (18).

6. The linear displacement system as claimed in claim 5, wherein
the electromagnetic linear drive (18) is designed as a synchronous drive (19), comprising:
having at least one primary coil (21) integrated in the motor carriage (15), and
a plurality of permanent magnets (20) integrated in the guide frame (11).

7. The linear displacement system as claimed in claim 6, wherein the permanent magnets (20) of the guide frame (11) are configured as flat panels (24) which are aligned in a row along the displacement direction (Y) of the linear drive (18) and are engaged on both sides by two primary coils (21) integrated in the motor carriage (15).

8. The linear displacement system as claimed in claim 1, wherein the motor carriage (15) is supported and guided relative to the guide frame (11) with the aid of an air bearing (25).

9. The linear displacement system as claimed in claim 1, wherein the base carriage (3) is joined to the motor carriage (3) by a rotary articulation (16).

10. The linear displacement system as claimed in claim 9, wherein the rotary articulation is arranged at a height (28) which corresponds to the height of the center of mass of the combination of the base carriage (3) and a load (4, 5, 6) arranged on the base carriage (3).

11. The linear displacement system as claimed in claim 1, wherein the base carriage (3) is connected on the opposite side (29) from the motor carriage or carriages (15, 15′) via a rotary articulation (32) to a head support (30) mounted so that it can be displaced relative to the floor surface (8).

12. The linear displacement system as claimed in claim 11, wherein the head support (30) is supported relative to the base carriage (3) via coupling elements (33).
